(19) United States
(12) Patent Application Publication
(10) Pub. No.: US 2015/0089247 A1
(43) Pub. Date: Mar. 26, 2015

(54) STORAGE MEDIUM HAVING SECURITY FUNCTION AND SECURITY METHOD THEREOF

(71) Applicant: Samsung Electronics Co., Ltd., Gyeonggi-do (KR)

(72) Inventors: Bo Gyeong KANG, Seoul (KR); Ji Soo Kim, Gyeonggi-do (KR); Jae Bum Lee, Gyeonggi-do (KR)

(73) Assignee: Samsung Electronics Co., Ltd.

(21) Appl. No.: 14/494,106

(22) Filed: Sep. 23, 2014

(30) Foreign Application Priority Data
Sep. 23, 2013 (KR) 10-2013-0112350

(51) Int. Cl. G06F 21/78; G06F 12/14; G06F 21/44

(52) U.S. Cl. CPC G06F 21/78; G06F 21/44; G06F 12/14; G06F 12/1408
USPC 713/193; 726/27

(57) ABSTRACT

A security method based on a memory unit for a user is provided. The security method includes receiving, from a server, a security code including a security service command for the user terminal and verification information certifying the security service command; determining whether the received verification information matches verification information stored in the memory unit; and performing, by the memory unit, a security action corresponding to the security service command, when the received verification information matches the stored verification information.

### PRIORITY

This application claims priority under 35 U.S.C. §119(a) to Korean Patent Application Serial No. 10-2013-0112350, which was filed in the Korean Intellectual Property Office on Sep. 23, 2013, the entire disclosure of which is incorporated herein by reference.

### BACKGROUND OF THE INVENTION

1. Field of the Invention

The present invention relates generally to a storage medium having a security function and security method thereof, and more particularly, to a device including a memory unit having a security function and a method of using the same.

2. Description of the Related Art

With advances in electronic technologies, modern user terminals support a variety of functions. Such user terminals utilize information stored in memory units. Importance of memory security has increased with diversification of terminal functions.

Basically, user terminals have evolved from simple telephones supporting only voice calls into multimedia appliances supporting complex functions such as capturing photographs and video, playing music or video files, gaming, broadcast reception, and electronic payment. As user terminals may store various multimedia information and confidential personal information of users, security issues are increasingly important.

As part of efforts to address security issues for user terminal, research has been conducted on schemes that can protect stored data from attacks of hackers and efficiently manage data between different applications.

In consideration of an environment where user terminals (high-end ones in particular) are frequently lost, research has been conducted on security schemes that can prevent loss of terminals and effectively protect stored personal information in the event of loss.

However, in the related art, a memory unit may perform a read or write operation according to a command from the controller but still may be unable to provide security operations such as control of access to a secure area and kill, unlock or lock services.

### SUMMARY OF THE INVENTION

Aspects of the present invention are to address at least the above mentioned problems and/or disadvantages and to provide at least the advantages described below.

Accordingly, an aspect of the present invention is to provide a device including a memory unit having a security function and a method of using the same.

Another aspect of the present invention is to provide a device and method in which a memory region can be used as a trusted storage allowing self access only.

Another aspect of the present invention is to provide an enhanced security method that, when a host device including a memory unit is lost, can disable a function of the host device at the memory level so that the host device is unusable.

In accordance with an aspect of the present invention, a security method based on a memory unit for a user terminal is provided. The security method includes receiving, from a server, a security code including a security service command for the user terminal and verification information certifying the security service command; determining whether the received verification information matches verification information stored in the memory unit; and performing, by the memory unit, a security action corresponding to the security service command, when the received verification information matches the stored verification information.

In accordance with another aspect of the present invention, a user terminal supporting a security service is provided. The user terminal includes a memory unit that performs a security function; a transceiver unit that receives a security code including a security service command for the user terminal and verification information certifying the security service command; and a control unit that forwards a received security code to the memory unit. The memory unit includes a memory controller that determines whether received verification information matches stored verification information and performs the security action corresponding to the received security service command, when the received verification information matches the stored verification information.

In accordance with another aspect of the present invention, a method for providing a secure area in a memory unit is provided. The method includes receiving a first command requesting access to the secure area; permitting access to the secure area, when the first command matches preset secure area access permission information; allocating, in the secure area, a memory space corresponding to a read or write command; receiving a second command requesting to block access to the secure area; and blocking access to the secure area, in response to the second command.

In accordance with another aspect of the present invention, a secure memory unit is provided. The secure memory unit includes a nonvolatile memory that stores cipher keys and data; and a memory controller that controls a process of receiving a first command requesting access to a secure area, permitting access to the secure area, when the first command matches preset secure area access permission information, allocating a memory space corresponding to a read or write command in the secure area, receiving a second command requesting to block access to the secure area, and blocking access to the secure area, in response to the second command.

### BRIEF DESCRIPTION OF THE DRAWINGS

The above and other aspects, features, and advantages of certain embodiments of the present invention will be more apparent from the following detailed description taken in conjunction with the accompanying drawings, in which:

FIG. 1 is a block diagram illustrating a general scheme for access control enforced at the operating system/kernel level, according to an embodiment of the present invention;

FIG. 2 is a block diagram of a secure memory unit, according to an embodiment of the present invention;

FIG. 3 is a block diagram illustrating a relationship between a secure memory unit and a host device, according to an embodiment of the present invention;

FIG. 4 is a flowchart illustrating a method for data encryption and decryption, according to an embodiment of the present invention;

FIG. 5 is a block diagram illustrating separation of memory regions initiated by a command, according to an embodiment of the present invention;

FIG. 6 is a flowchart illustrating a method for separation of memory regions initiated by a command, according to an embodiment of the present invention;

FIG. 7 is a block diagram illustrating management of separate secure areas for different applications, according to an embodiment of the present invention;

FIG. 8 is a signaling diagram illustrating management of separate secure areas for different applications, according to an embodiment of the present invention;

FIG. 9 is a signaling diagram illustrating memory-provided service operations when a user terminal is lost, according to an embodiment of the present invention;

FIG. 10 is a block diagram illustrating a host device, according to an embodiment of the present invention;

FIG. 11 is a flowchart illustrating a method for security operations of the secure memory unit, according to an embodiment of the present invention; and

FIG. 12 is block diagram illustrating a system that provides security services in the event of loss of a user terminal, according to an embodiment of the present invention.

### DETAILED DESCRIPTION OF EMBODIMENTS OF THE PRESENT INVENTION

Hereinafter, embodiments of the present invention are described in detail with reference to the accompanying drawings. Those of ordinary skill in the art will recognize that various changes and modifications of the embodiments described herein can be made without departing from the scope of the present invention. In addition, descriptions of well-known functions and constructions may be omitted for clarity and conciseness. The same reference symbols are used throughout the drawings to refer to the same or like parts.

It should be noted that various embodiments described below may be applied or used individually or in combination.

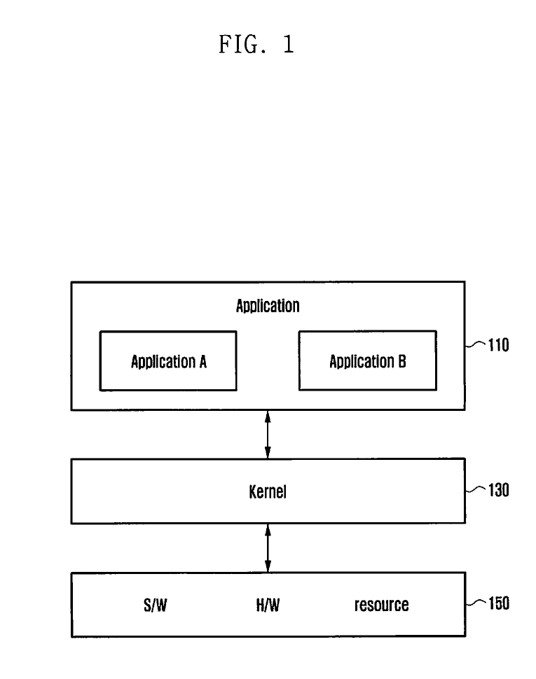

FIG. 1 is a block diagram illustrating a general scheme for access control enforced at the operating system/kernel level, according to an embodiment of the present invention.

An application area 110, a kernel area 130, and a resource area 150 are shown in FIG. 1. Multiple applications may be processed in the application area 110. The kernel area 130, which is placed between the application area 110 and the resource area 150, provides various services for program execution. The kernel area 130 efficiently manages system resources for smooth program execution. To this end, the kernel area 130 schedules software and hardware resources so that programs can be smoothly executed.

The application area 110 may have signature or authentication information for each application. This signature or authentication information may be used to ensure security of data associated with an application. Data associated with an application may be secured through signing or authentication and may be stored according to scheduling of the kernel area 130. In this case, separate encryption is not performed in a memory region where data is actually stored. However, a security scheme based on signature or authentication information in the application area has been found to be vulnerable to a security attack. Hence, to protect user information, it is necessary to develop a scheme that performs a security function directly at a memory region.

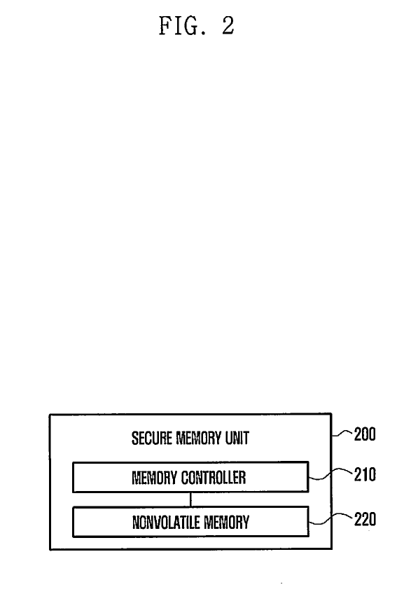

FIG. 2 is a block diagram of a secure memory unit 200, according to an embodiment of the present invention.

Referring to FIG. 2, the secure memory unit 200 includes a memory controller 210 and a nonvolatile memory 220. The secure memory unit 200 is a storage medium that includes a nonvolatile memory capable of storing media content and programs to operate an electronic device. The memory controller 210 and nonvolatile memory 220 may be integrated in a semiconductor device.

The memory controller 210 controls data-in and data-out operations of the nonvolatile memory 220 in response to a command received from the outside. When the secure memory unit 200 is installed in a host device, the memory controller 210 interconnects the host device and the nonvolatile memory 220. That is, the memory controller 210 provides an interface between the nonvolatile memory 220 and the host device. In response to a request from the host device, the memory controller 210 accesses the nonvolatile memory 220. The memory controller 210 is configured to drive firmware to control the nonvolatile memory 220.

The nonvolatile memory 220 is a memory element that keeps stored information even when not powered. For example, the nonvolatile memory 220 may be a chip or package composed of NAND flash memory, NOR flash memory, phase-change random access memory (PRAM), magnetic random access memory (MRAM), or resistive random access memory (RRAM). With regard to packaging, memory elements may be packaged and mounted in various forms, such as Package on Package (PoP), Ball Grid Array (BGA), Chip Scale Package (CSP), Plastic Leaded Chip Carrier (PLCC), Plastic Dual In Line Package (PDIP), Die in Waffle Pack (DWP), Die in Wafer Form (DWF), Chip On Board (COB), Ceramic Dual In Line Package (CERDIP), Plastic Metric Quad Flat Pack (PMQFP), Thin Quad Flatpack (TQFP), Small Outline (SOIC), Shrink Small Outline Package (SSOP), Thin Small Outline (TSOP), Thin Quad Flatpack (TQFP), System In Package (SIP), Multi Chip Package (MCP), Wafer-level Fabricated Package (WFP), and Wafer-Level Processed Stack Package (WSP).

The nonvolatile memory 220 is an area in which data is stored in the secure memory unit 200 and performs data manipulation operations such as store, remove, input and output under control of the memory controller 210. The nonvolatile memory 220 stores cipher keys for encryption at the memory level.

In accordance with an embodiment of the present invention, the memory controller 210 determines whether received verification information matches verification information stored in the embedded memory (i.e. secure memory unit) of the user terminal and controls the embedded memory to perform a security operation corresponding to a security service command for the user terminal if the received verification information matches the stored verification information.

The memory controller 210 encrypts data to be stored using verification information and cipher keys stored in the embedded memory. The memory controller 210 removes a cipher key to block access to the stored data that has been encrypted using the cipher key.

The memory controller 210 changes firmware configured in the embedded memory. For example, the memory controller 210 removes the firmware or set an error bit in the firmware.

Upon reception of a first command serving as a request for access to the secure area, if the first command matches preset secure area access permission information, the memory controller 210 permits access to the secure area and allocates space corresponding to a read or write command in the secure area. Upon receipt of a second command requesting to block access to the secure area, the memory controller 210 blocks access to the secure area. In addition, when the second command is not received for a preset time after reception of the first command, the memory controller 210 blocks access to the secure area.

The memory controller 210 receives security information associated with a trusted application and allocates a space in the secure area corresponding to the trusted application.

The memory controller 210 identifies an application using the Universally Unique Identifier (UUID) contained in the security information, and allocates a secure area for the application using a PAD number contained in the security information. The memory controller 210 performs encryption and decryption using the UUID and cipher key stored in the secure memory unit.

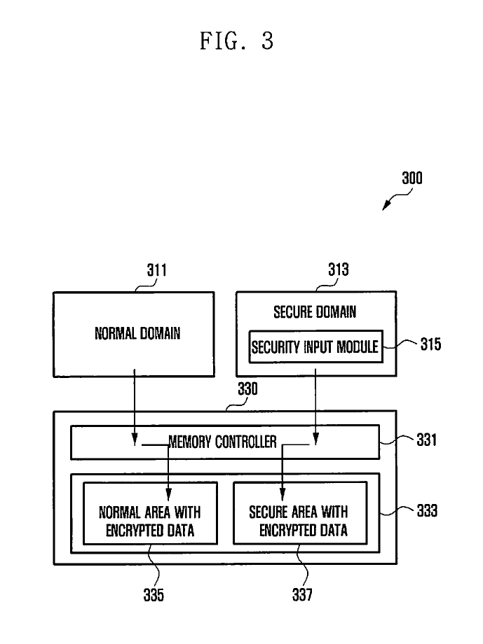

FIG. 3 is a block diagram illustrating the relationship between a secure memory unit and a host device, according to an embodiment of the present invention.

In FIG. 3, information regarding applications residing in the normal domain 311 and secure domain 313 configured in the host device 300 is securely managed in the secure memory unit 200.

The host device 300 is a user terminal having a secure memory unit, such as a smartphone, tablet computer, television set, set-top box, and computer. The host device 300 utilizes multiple applications having various functions. Such applications may require different levels of security according to their characteristics.

In the host device 300, the normal domain 311 is a zone managed by a normal operating system. The secure domain 313 is a zone managed by a secure operating system and may be separated from the normal domain 311. The secure operating system manages business related applications and security-critical applications such as trusted applications (TA). For example, trusted applications may include applications requiring a high level of security, such as a Digital Rights Management (DRM) application, financial application, identity authentication application, etc.

The secure memory unit 330 includes a memory controller 331 and a nonvolatile memory 333. The nonvolatile memory 333 includes a normal area 335 for encrypted normal data and a secure area 337 for encrypted secure data. The normal area 335 and the secure area 337 may be separated by a hardware mechanism or a logical mechanism. The nonvolatile memory 333 stores cipher keys for encryption at the memory level. Cipher keys for applications residing in the normal domain 311 may be managed separately from those for applications residing in the secure domain 313.

The memory controller 331 receives a request for the secure memory unit 330 from the host device 300 and handles the request. For a response as to an application in the normal domain 311, the memory controller 331 encrypts data using a cipher key stored in the secure memory unit 330 and stores the encrypted data in the normal area 335. Here, the cipher key may be a cipher key designed for an application in the normal domain 311. For a request for data stored in the normal area 335, the memory controller 331 decrypts the data using the cipher key used at the time of encryption and utilize the decrypted data.

For a response as to an application in the secure domain 313, the memory controller 331 encrypts data using a cipher key stored in the secure memory unit 330 and stores the encrypted data in the secure area 337. Here, the cipher key may be a cipher key designed for an application in the secure domain 313.

A security input module 315 may be needed to utilize data associated with an application in the secure domain 313. The security input module 315 may be used to input security information, which is needed to access encrypted data in the secure area. The security information may be the same for all applications in the secure domain 313 or may be different for individual applications. The security information includes ID, password and certificate information. The memory controller 331 performs data encryption using both the security information and cipher keys stored in the secure memory unit 330. The cipher keys may be information corresponding to the slot of the secure memory unit.

For a request for data stored in the secure area 337, the memory controller 331 decrypts the data using the cipher key used at the time of encryption and utilizes the decrypted data.

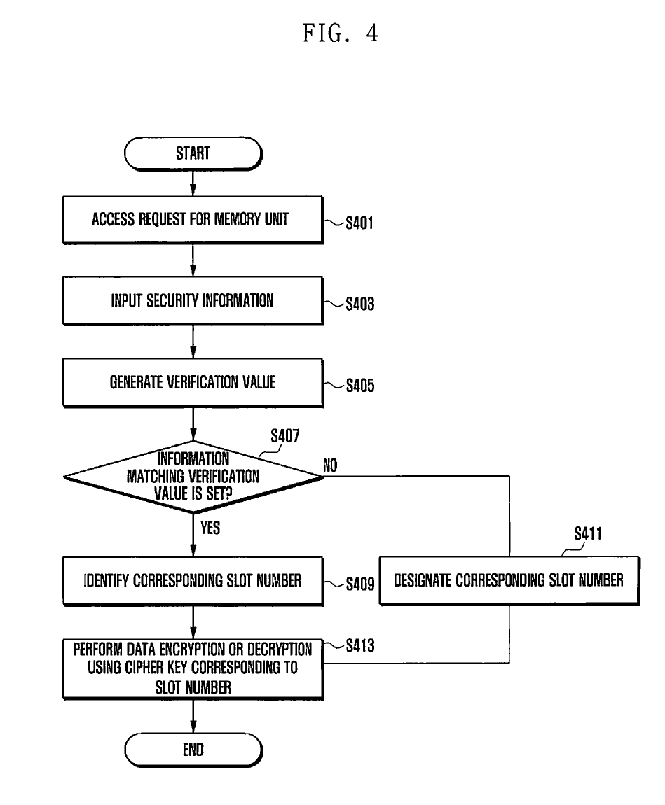

FIG. 4 is a flowchart illustrating a method for data encryption and decryption, according to an embodiment of the present invention.

Referring to FIG. 4, at step S401, an access request for the secure memory unit is received for data encryption or decryption. At step S403, security information is input to access encrypted data stored in the secure area of the secure memory unit. Here, the security information may be ID, password or authentication information. At step S405, a verification value corresponding to the security information is generated and delivered to the secure memory unit. The verification value may be generated through a one-way function. For example, the verification value may be a hash value generated by a hash function. That is, to access encrypted data stored in the secure area of the secure memory unit, an ID or password entered as security information is converted by a one-way function such as a hash function into a verification value, which is then forwarded to the secure memory unit.

At step S407, the secure memory unit checks whether configuration information matching the received verification value is set. Here, the configuration information may be a slot number corresponding to the verification value. If configuration information matching the received verification value is set, the procedure proceeds to step S409 at which the secure memory unit identifies the slot number corresponding to the received verification value. If configuration information matching the received verification value is not set, the procedure proceeds to step S411 at which the secure memory unit designates a slot number corresponding to the received verification value. After identifying the slot number at step S409 or after designating a slot number at step S411, at step S413, data encryption or decryption is performed using a cipher key corresponding to the slot number.

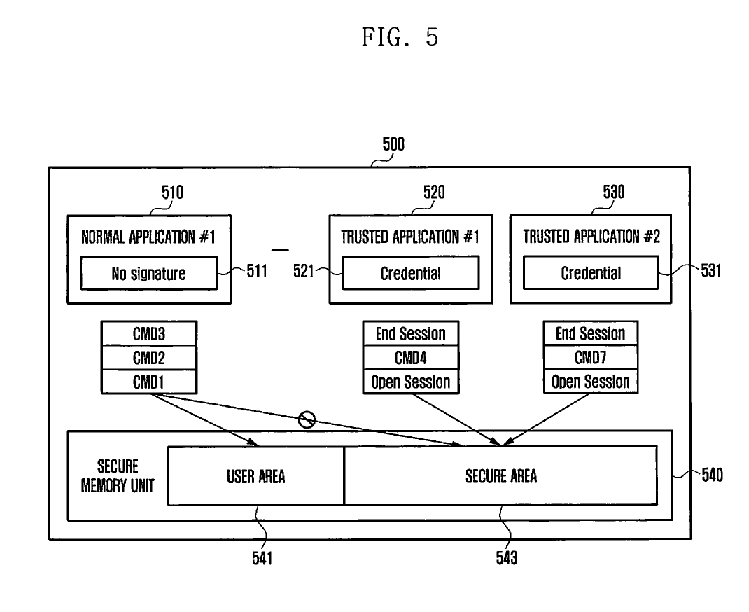

FIG. 5 is a block diagram illustrating separation of memory regions initiated by a command, according to an embodiment of the present invention.

FIG. 5 depicts a logical relationship between applications 510, 520, and 530 residing in the host device 500 and the secure memory unit 540. The host device 500 provides various functions by use of multiple applications. The normal application 510 is an application without signature information and may require a lower level of security compared with a trusted application. The normal application 510 may be stored in a user area 541 of the secure memory unit 540. A read command or write command for the secure memory unit 540 may be used to read data from or write data in the user area 541 of the secure memory unit 540. The normal application 510 cannot be stored in the secure area 543. However, in certain embodiments this is not the case.

The trusted applications 520 and 530 require a higher level of security compared with a normal application. For example, the trusted applications 520 and 530 may be an application related to banking, authentication or identity verification. Each trusted application 520 or 530 includes a credential 521 or 531, respectively. The credential 521 or 531 includes security information of a corresponding application, such as a secret key, address of an accessible secure area and signature.

The trusted applications 520 or 530 issue special commands for access to the secure area 543 of the secure memory unit 540. The commands for access to the secure area include a first command issued for access initiation and a second command issued for access termination. For example, the first command may be referred to as the open session command, and the second command may be referred to as the close session command. The trusted applications 520 or 530 issue the first command, second command, read command, and write command. Such commands may be sent by the controller of the host device to the secure memory unit. The trusted applications 520 or 530 issue the first command, a read or write command, and the second command in this sequence. According to this sequence of commands, the secure memory unit 540 allocates a memory block in the secure area 543. To access the secure area 543 of the secure memory unit 540 for data read or write, the trusted applications 520 or 530 send the first command to the secure memory unit 540. If the first command is not sent, access to the secure area 543 for data read or write is not allowed. When the secure memory unit 540 receives the first command, it permits the trusted application to access the secure area 543. After permitting access to the secure area 543, the secure memory unit 540 allocates a space in the secure area 543 according to a read or write command from the trusted application. After completion of the read or write operation, the trusted application sends the second command. Upon reception of the second command, the secure memory unit 540 blocks access to the secure area 543. On the other hand, when the second command is not received for a preset time or more after reception of the first command, the secure memory unit 540 blocks access to the secure area and directly terminate the session.

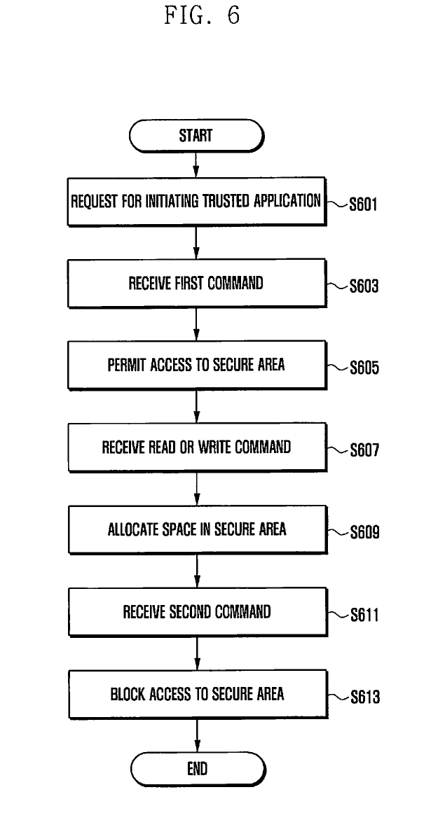

FIG. 6 is a flowchart illustrating a method for separation of memory regions initiated by a command, according to an embodiment of the present invention.

Referring to FIG. 6, at step S601, a request for initiating a trusted application is received. At step S603, the trusted application sends the first command and the secure memory unit receives the first command. Upon reception of the first command, at step S605, the secure memory unit permits the trusted application to access the secure area. At step S607, the secure memory unit receives a read or write command. Upon reception of a read or write command, at step S609, the secure memory unit allocates a space in the secure area. A normal application not sending the first command is not allowed to access the secure area. Steps S607 and S609 may be repeated. At step S611, the secure memory unit receives the second command.

Upon reception of the second command, at step S613, the secure memory unit blocks access of the trusted application to the secure area.

When the second command is not received for a preset time or more after reception of the first command, the secure memory unit may also block access to the secure area. According to user settings, when a read or write command is not received for a preset time or more at step S607, the secure memory unit blocks access to the secure area.

As described above, access to the secure area may be allowed and blocked according to a sequence of the first command, one or more read or write commands, and the second command, and a normal application not issuing the first command or second command may be not allowed to access the second command. Access control may be applied to a normal application and a trusted application by use of a secure memory unit divided into the user area and the secure area and preset commands.

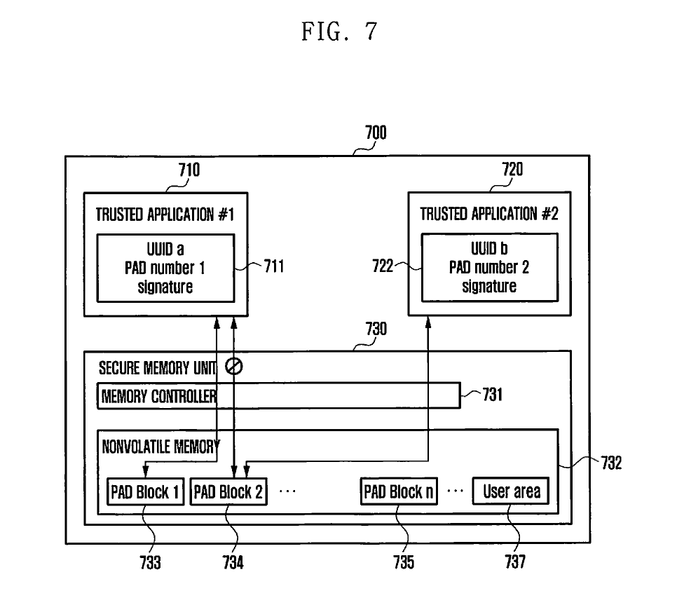

FIG. 7 is a block diagram illustrating management of separate secure areas for different applications, according to an embodiment of the present invention.

Referring to FIG. 7, multiple trusted applications 710 and 720 reside in the host device 700. In FIG. 7, separate regions of the secure memory unit are assigned to individual trusted applications with encryption.

Each trusted application 710 or 720 may have a credential including a UUID, PAD number and signature as security information. To access the secure area, the trusted application 710 sends an access command. Here, the access commands may be similar to those described in FIGS. 5 and 6. The trusted application 710 sends the first command as an access request for the secure area. The first command may be sent together with the credential.

Upon reception of the first command from the trusted application 710, the secure memory unit verifies the credential of the trusted application 710. If the credential is valid, a secure memory unit 730 permits access to a secure area corresponding to index information (e.g. PAD number) of the trusted application 710 through a memory controller 731. The secure memory unit 730 allocates a PAD block corresponding to the index information as a secure area. Here, the PAD block may be used to read or write data.

For example, in FIG. 7, a PAD block 733 is a PAD block allocated to the trusted application 710. If the credential of the trusted application 710 is successfully verified, the trusted application 710 may be allowed to access the PAD block 733 for data read or write.

A trusted application cannot access a PAD block not matching the credential thereof. As the PAD block 734 is a PAD block allocated to the trusted application 720, the trusted application 720 cannot access a PAD block other than the PAD block 734 for read or write. As described above, the secure memory unit 730 manages separate PAD blocks for individual trusted applications, raising the level of security for each application.

The secure memory unit 730 encrypts or decrypts data of each PAD block using a stored cipher key. The secure memory unit 730 maintains a table of cipher keys corresponding to individual PAD blocks. Other data structures such as a list may also be used for managing cipher keys. After reception of the first command, the secure memory unit 730 encrypts or decrypts data of the access allowed PAD block using the UUID and stored cipher key. Without an assigned cipher key, data of the corresponding secure area (PAD block) cannot be encrypted or decrypted.

When the second command is received from the trusted application, the secure memory unit 730 blocks access to the secure area allocated to the trusted application.

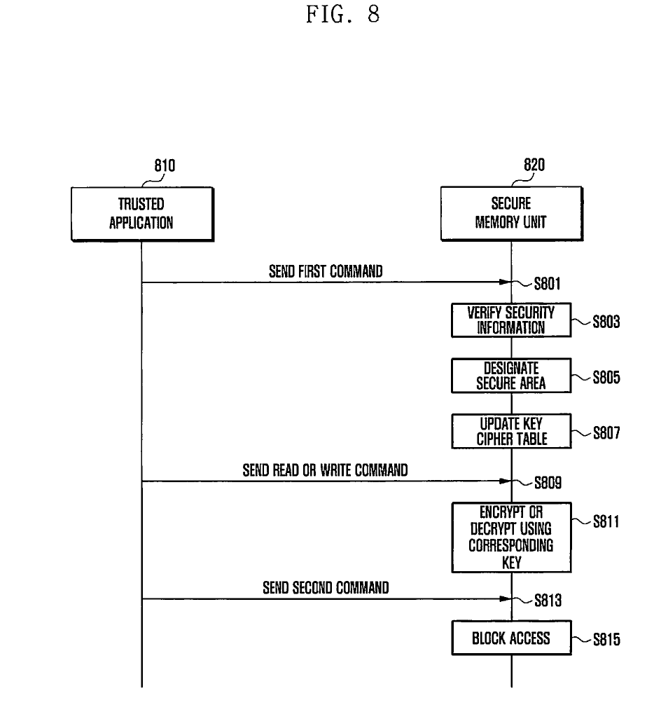

FIG. 8 is a signaling diagram illustrating management of separate secure areas for different applications, according to an embodiment of the present invention.

Referring to FIG. 8, at step S801, the trusted application 810 sends the first command to the secure memory unit 820 for secure area access. The trusted application 810 sends a credential including a UUID, PAD number and signature together with the first command.

Upon reception of the first command, at step S803, the secure memory unit 820 verifies the credential. If the credential is successfully verified, at step S805, the secure memory unit 820 designates a secure area corresponding to the trusted application 810. Here, the secure area may be a PAD block corresponding to the trusted application 810.

The secure memory unit 820 manages a table of cipher keys corresponding to PAD blocks and UUIDs. At step S807, the secure memory unit 820 identifies the cipher key corresponding to the PAD block and updates the table of cipher keys. The secure memory unit 820 uses the identified cipher key to encrypt or decrypt data of the PAD block for read or write operation.

Upon obtaining access permission, at step S809, the trusted application 810 sends a read or write command. In response to the read or write command, at step S811, the secure memory unit 820 encrypts data using the cipher key and stores the encrypted data in the PAD block or decrypts data stored in the PAD block using the cipher key and outputs the decrypted data. Steps S809 and S811 may be repeated as a unit. The secure memory unit 820 performs data encryption or decryption in response to reception of a write or read command.

At step S813, the trusted application 810 sends the second command.

Upon reception of the second command, at step S815, the secure memory unit 820 blocks access of the trusted application 810 to the secure area.

When the second command is not received for a preset time or more after reception of the first command at step S801, or when the second command or a new read or write command is not received for a preset time or more after reception of a read or write command at step S809, the secure memory unit 820 blocks access of the trusted application 810 to the secure area.

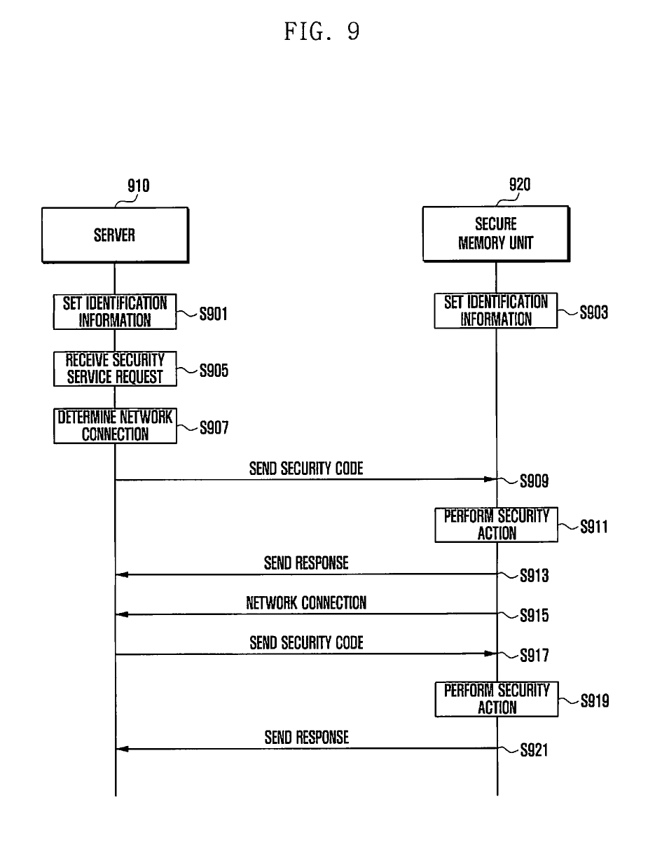

FIG. 9 is a signaling diagram illustrating memory-provided service operations when a user terminal is lost, according to an embodiment of the present invention.

Referring to FIG. 9, a host device having a secure memory unit 920 communicates with a server 910 and performs a security service operation provided by the secure memory unit 920. In the embodiment of FIG. 9, when the host device is lost or stolen, data stored in the host device may be removed or the host device is disabled through security service operations provided by the secure memory unit.

This feature may be referred to as a kill service. In the case where such a kill service is provided by an application running on the operating system, when the application is removed from the host device, the kill service is unavailable. Hence, it is preferable to provide the kill service at the memory level in terms of safety and efficiency.

At steps S901 and S903, identification information is registered in the server and the host device. In embodiments of the present invention, the steps S901 and S903 may be omitted. The identification information is to uniquely identify the host device and the user thereof. For example, a user ID and password may be used as the identification information. Such user ID and password may be stored as a verification value in the secure memory unit by use of a one-way function such as a hash function. Later, the stored verification value may be used to validate a security service command from the server when a security service is requested.

At step S905, the server receives a security service request. The user enters the identification information to make a security service request for the host device. The security service request indicates one or more of various security measures such as removing firmware of the secure memory unit, setting an error bit in firmware, removing data, removing slot number, blocking read and write, and unblocking read and write.

For example, the following security service commands may be used. Other commands may also be used.

Kill (firmware, Hash(ID,PW)): remove firmware, set an error bit in firmware.

Kill (data, Hash(ID,PW)): remove all data, remove slot number matching Hash(ID,PW) in key table.

Lock (all, Hash(ID,PW)): prohibit read/write.

Lock (secure area address, Hash(ID,PW): prohibit read/write on specified secure area.

Unlock (all, Hash(ID,PW)): allow read/write.

The memory controller of the secure memory unit may be pre-configured to perform an action in response to reception of such a security code. In this case, the secure memory unit may directly perform a security action corresponding to a received security code independently of an action of the trusted application or secure operating system.

At step S907, the server determines whether the host device is connected to the network. If the host device is connected to the network, at step S909, the server sends a security code. Here, the security code includes a security service command and a verification value. The verification value can be used by the secure memory unit to validate the security service command. The verification value may be a value of a given one-way function. That is, the server may send verification information (such as a hash value corresponding to the user ID/password) to the secure memory unit.

Upon reception of the security code, at step S911, the secure memory unit 920 determines whether the verification value of the received security code matches the stored verification value. If the received verification value matches the stored verification value, the secure memory unit performs a security action corresponding to the security service command. That is, the secure memory unit removes the firmware, sets an error bit in firmware, removes data, removes slot number, blocks read and write, or unblocks read and write.

As described above, the secure memory unit 920 stores data that is encrypted using a preset verification value and a cipher key corresponding to the slot thereof. In response to the security service command, cipher keys stored in the secure memory unit 920 may be removed. Removal of cipher keys blocks access to the nonvolatile memory of the secure memory unit 920. Information on the mapping between the verification value and cipher key may be initialized or removed. The information on the mapping may be the address of stored keys or the slot number of the key table.

When stored cipher keys are removed or cipher key mapping information is initialized or removed, encrypted data of the secure memory unit 920 cannot be decrypted for reading or data cannot be encrypted for writing, rendering the secure memory unit 920 useless.

At step S913, the secure memory unit 920 sends a security action response to the server 910 as a reply to the received security code.

If the host device is not connected to the network at step S907, the server 910 waits for the host device to connect to the network. In a wait state, at step S915, the server 910 detects network connection of the host device. The server 910 receives a signal indicating network connection from the host device or from a registration server to which the host device is subscribed.

If the host device is connected to the network, at step S917, the server sends a security code. Here, the security code includes a security service command and a verification value. The verification value can be used by the secure memory unit 920 to validate the security service command. The verification value may be a value of a given one-way function.

Upon reception of the security code, at step S919, the secure memory unit 920 determines whether the verification value of the received security code matches the stored verification value. If the received verification value matches the stored verification value, the secure memory unit performs a security action corresponding to the security service command. That is, the secure memory unit 920 removes the firmware, sets an error bit in firmware, removes data, removes slot number, blocks read and write, or unblocks read and write.

At step S921, the secure memory unit 920 sends a security action response to the server 910 as a reply to the security code received at step S917.

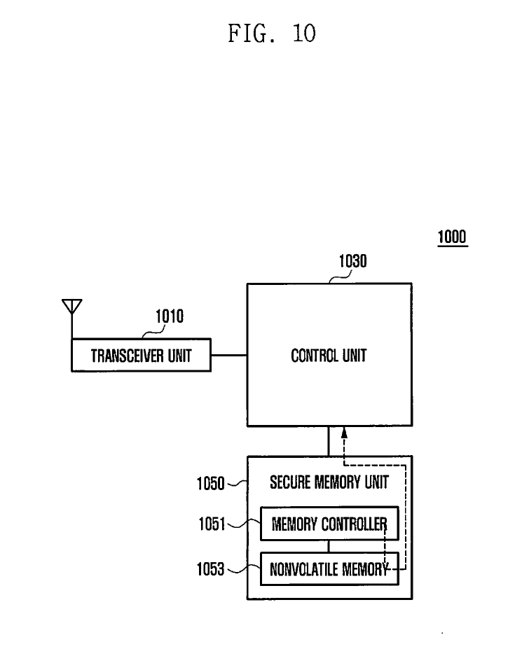

FIG. 10 is a block diagram illustrating a host device, according to an embodiment of the present invention.

Referring to FIG. 10, a host device 1000 includes a transceiver unit 1010, a control unit 1030, and a secure memory unit 1050.

The transceiver unit 1010 sends and receives data to and from an external device under control of the control unit 1030. The transceiver unit 1010 connects to an external network for communication and receives a security code from a given server.

The control unit 1030 controls the overall operation of the host device 1000. In embodiments of the present invention, a normal application or trusted application sends a message to the secure memory unit 1050. The control unit 1030 controls message transmission toward the secure memory unit 1050. The control unit 1030 sends a read or write command for data to the secure memory unit 1050. The control unit 1030 receives data from the secure memory unit 1050.

In addition, the control unit 1030 forwards a security code received from a server to the secure memory unit 1050.

The secure memory unit 1050 includes a memory controller 1051 and a nonvolatile memory 1053.

The memory controller 1051 controls data-in and data-out operations of the nonvolatile memory 1053 in response to a command received from the outside. When the secure memory unit 1050 is installed in the host device, the memory controller 1051 interconnects the host device and the nonvolatile memory 1053. That is, the memory controller 1051 provides an interface between the nonvolatile memory 1053 and the host device. In response to a request from the host device, the memory controller 1051 accesses the nonvolatile memory 1053. The memory controller 1051 is configured to drive firmware to control the nonvolatile memory 1053.

The nonvolatile memory 1053 is an area in which data is stored in the secure memory unit 1050 and performs data manipulation operations such as store, remove, input and output under control of the memory controller 1051. The nonvolatile memory 1053 stores cipher keys for encryption at the memory level. Under control of the memory controller 1051, the nonvolatile memory 1053 pre-stores a series of actions to be performed by the secure memory unit 1050 according to a security code received from the server.

The memory controller 1051 determines whether received verification information matches verification information stored in the embedded memory (i.e. secure memory unit) of the user terminal, and control the embedded memory to perform a security action corresponding to a security service command for the user terminal if the received verification information matches the stored verification information.

The memory controller 1051 encrypts data to be stored using verification information and cipher keys stored in the embedded memory. The memory controller 1051 removes a cipher key to block access to the stored data that has been encrypted using the cipher key.

The memory controller 1051 changes firmware configured in the embedded memory. For example, the memory controller 1051 removes the firmware or set an error bit in the firmware.

Upon reception of a first command serving as a request for access to the secure area, if the first command matches preset access permission information, the memory controller 1051 permits access to the secure area and allocate space corresponding to a read or write command in the secure area. Upon reception of a second command serving as a request for blocking access to the secure area, the memory controller 1051 blocks access to the secure area. In addition, when the second command is not received for a preset time after reception of the first command, the memory controller 1051 blocks access to the secure area.

The memory controller 1051 receives security information associated with a trusted application and allocates a space in the secure area corresponding to the trusted application.

The memory controller 1051 identifies an application using a UUID contained in the security information and allocates a secure area for the application using a PAD number contained in the security information. The memory controller 1051 performs encryption and decryption using the UUID and cipher key stored in the secure memory unit.

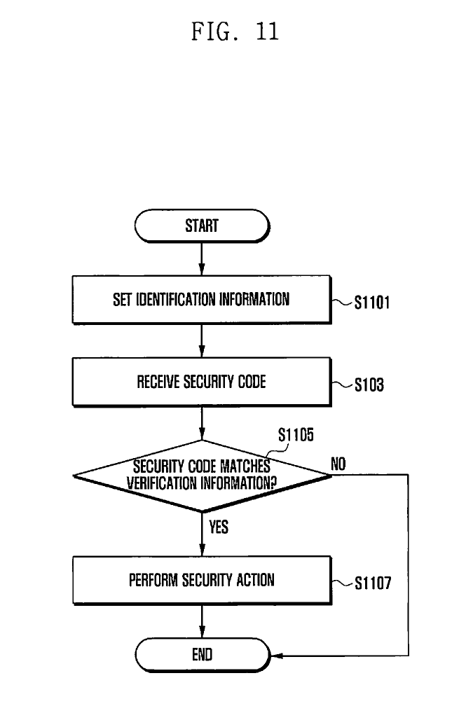

FIG. 11 is a flowchart illustrating a method for security operations of the secure memory unit, according to an embodiment of the present invention.

Referring to FIG. 11, at step S1101, the secure memory unit configures and sets identification information. The identification information is to uniquely identify the host device and the user thereof. For example, a user ID and password may be used as the identification information.

At step S1103, the secure memory unit receives a security code. Here, the security code includes a security service command for the user terminal and verification information therefor. The verification information can be used by the secure memory unit to validate the security service command.

The security service command indicates one or more of various security services such as removing firmware of the secure memory unit, setting an error bit in firmware, removing data, removing slot number, blocking read and write, and unblocking read and write.

The verification information may be used by the secure memory unit to validate the security service command. The verification information may be a value of a given one-way function.

At step S1105, the secure memory unit checks whether the received security code matches the stored verification information.

If the received security code matches the stored verification information, at step S1107, the secure memory unit performs a security action corresponding to the security service command.

As described above, the memory controller of the secure memory unit may be pre-configured to perform an action in response to reception of such a security code. In this case, the secure memory unit may directly perform a security action corresponding to the received security code independently of an action of the trusted application or secure operating system.

The security action corresponds to one or more of removing firmware of the secure memory unit, setting an error bit in firmware, removing data, removing slot number, blocking read and write, and unblocking read and write.

As described above, the secure memory unit stores data that is encrypted using preset verification information and a cipher key corresponding to the slot thereof. In response to the security service command, cipher keys stored in the secure memory unit may be removed. Removal of cipher keys blocks access to the nonvolatile memory of the secure memory unit. When stored cipher keys are removed, encrypted data of the secure memory unit cannot be decrypted for reading or data cannot be encrypted for writing, rendering the secure memory unit useless.

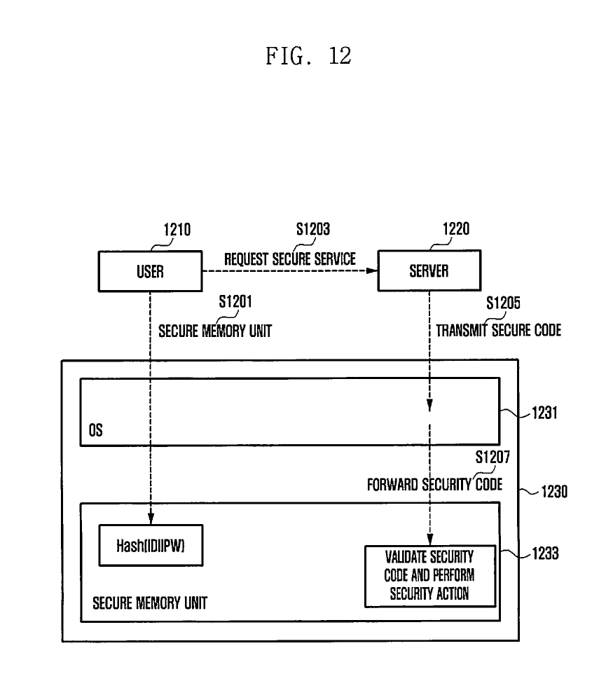

FIG. 12 is block diagram illustrating a system that provides security services in the event of loss of a user terminal, according to an embodiment of the present invention.

Referring to FIG. 12, a user 1210 sets a user ID and password in the user terminal 1230 and the server 1220. Hash information corresponding to the user ID and password set by the user may be stored in the user terminal 1230 and the server 1220. If necessary in the event of loss of the user terminal, the user issues a security service request to the server (Web account).

In response to the security service request, the server 1220 sends a service command (such as kill/lock) and hash information (as verification information usable by the secure memory unit 1233 for the service command) to the user terminal 1230.

The secure memory unit 1233 compares the hash information generated using the user ID and password with the hash information received from the server. If the generated hash information matches the received hash information, the secure memory unit 1233 performs the security service command received from the server.

While the present invention has been shown and described with reference to various embodiments thereof, it should be understood by those skilled in the art that many variations and modifications of the method and apparatus described herein will still fall within the spirit and scope of the present invention as defined in the appended claims and their equivalents.

What is claimed is:

1. A security method based on a memory unit for a user terminal, the security method comprising:
receiving, from a server, a security code including a security service command for the user terminal and verification information certifying the security service command;
determining whether the received verification information matches verification information stored in the memory unit; and
performing, by the memory unit, a security action corresponding to the security service command, when the received verification information matches the stored verification information.

2. The security method of claim 1, wherein the memory unit comprises an embedded memory device included in the user terminal, and
wherein the memory unit is configured to store instructions for security actions corresponding to security codes.

3. The security method of claim 1, further comprising:
encrypting data using the verification information and a cipher key stored in the memory unit; and
storing the encrypted data.

4. The security method of claim 3, wherein performing the security action comprises blocking access to the stored encrypted data by one of initializing and removing information on the mapping between the verification information and the cipher key.

5. The security method of claim 1, wherein performing the security action comprises setting an error bit in firmware of the memory unit.

6. A user terminal supporting a security service, the user terminal comprising:
a memory unit that performs a security function;
a transceiver unit that receives a security code including a security service command for the user terminal and verification information certifying the security service command; and
a control unit that forwards a received security code to the memory unit,
wherein the memory unit includes a memory controller that determines whether received verification information matches stored verification information and performs the security action corresponding to the received security service command, when the received verification information matches the stored verification information.

7. The user terminal of claim 6, wherein the memory unit comprises an embedded memory device included in the user terminal, and
wherein the memory unit is configured to store instructions for security actions corresponding to security codes.

8. The user terminal of claim 6, wherein the memory controller encrypts data using verification information and a cipher key stored in the memory unit and stores the encrypted data.

9. The user terminal of claim 8, wherein the memory controller blocks access to the stored encrypted data by initializing or removing information on the mapping between the verification information and the cipher key.

10. The user terminal of claim 6, wherein the memory controller performs a security action by setting an error bit in firmware of the memory unit.

11. A method for providing a secure area in a memory unit, the method comprising:
receiving a first command requesting access to the secure area;
permitting access to the secure area, when the first command matches preset secure area access permission information;
allocating, in the secure area, a memory space corresponding to a read or write command;
receiving a second command requesting to block access to the secure area; and
blocking access to the secure area, in response to the second command.

12. The method of claim 11, further comprising blocking access to the secure area, when the second command is not received for a preset time after reception of the first command.

13. The method of claim 11, further comprising receiving security information associated with a trusted application,
wherein allocating the memory space comprises allocating a memory space in a secure area corresponding to the trusted application.

14. The method of claim 13, wherein allocating the memory space in a secure area corresponding to the trusted application comprises:
identifying the trusted application using universally unique identifier (UUID) information included in the security information; and
designating the secure area corresponding to the trusted application using a PAD number included in the security information.

15. The method of claim 14, further comprising performing encryption or decryption using the UUID information and a cipher key stored in the memory unit.

16. A secure memory unit comprising:
a nonvolatile memory that stores cipher keys and data; and
a memory controller that controls a process of receiving a first command requesting access to a secure area, permitting access to the secure area, when the first command matches preset secure area access permission information, allocating a memory space corresponding to a read or write command in the secure area, receiving a second command requesting to block access to the secure area, and blocking access to the secure area, in response to the second command.

17. The secure memory unit of claim 16, wherein the memory controller blocks access to the secure area, when the second command is not received for a preset time after reception of the first command.

18. The secure memory unit of claim 16, wherein the memory controller receives security information associated with a trusted application and allocates a memory space in a secure area corresponding to the trusted application.

19. The secure memory unit of claim 18, wherein the memory controller identifies the trusted application using universally unique identifier (UUID) information included in the security information, and designates a secure area corresponding to the trusted application using a PAD number included in the security information.

20. The secure memory unit of claim 19, wherein the memory controller performs encryption or decryption using the UUID information and a cipher key stored in the secure memory unit.
